(19) United States
(12) Patent Application Publication
(10) Pub. No.: US 2003/0229728 A1
(43) Pub. Date: Dec. 11, 2003

(54) Apparatus and methods for circuit characterization by using a simulation compiler

(75) Inventor: Paul R. Hodges, Austin, TX (US)

Correspondence Address: O'KEEFE, EGAN & PETERMAN, L.L.P, Building C, Suite 200, 1101 Capital of Texas Highway South, Austin, TX, 78746, US

(73) Assignee: SILICON METRICS CORPORATION, Austin, TX (US)

(21) Appl. No.: 10/456,404

(22) Filed: Jun. 6, 2003

Related U.S. Application Data
(60) Provisional application No. 60/387,479, filed on Jun. 10, 2002.

(51) Int. Cl. G06F 9/46

(52) U.S. Cl. 709/328

(57) ABSTRACT

A system for characterizing an electronic circuit includes a computer. The computer is adapted to provide an object-oriented application program interface (API) to specify a simulation model of the circuit. The computer is further adapted to translate the specified simulation model of the circuit to at least one desired circuit simulator.

### CROSS-REFERENCE TO RELATED APPLICATIONS

This application claims priority to Provisional U.S. Patent Application Serial No. 60/387,479, Attorney Docket Number SIME:013PZ1, titled “Simulation Compiler,” and filed on Jun. 10, 2002.

### TECHNICAL FIELD

This invention relates generally to circuit and cell characterization and, more particularly, to apparatus and methods for circuit characterization by using a simulation compiler.

### BACKGROUND

The design cycles of circuits, such as integrated circuits (ICs), and systems typically includes characterization of electronic circuitry. Normally, one uses electronic design automation (EDA) tools to facilitate circuit characterization. An EDA tool typically includes computer code, software, or program(s) for circuit simulation that execute on a computer.

Because of the variety of EDA tools on the market, a relatively large number of simulator products exist. Thus, designing simulations that are simulator-independent can pose a challenge. A need exists for designing simulations to make the measurements of the circuit characteristics (e.g., transient analysis, power dissipation analysis, etc.) in a simulator independent fashion.

### SUMMARY

This invention contemplates circuit characterization tools that use a simulation compiler. One aspect of the invention relates to systems for circuit characterization. In an exemplary embodiment, a system for characterizing an electronic circuit includes a computer. The computer is adapted to provide an object-oriented application program interface (API) to specify a simulation model of the circuit. The computer is further adapted to translate the specified simulation model of the circuit to at least one desired circuit simulator.

A second aspect of the invention concerns methods of characterizing a circuit. In one exemplary embodiment, a method according to the invention includes providing an object-oriented application program interface (API) to specify a simulation model of the circuit. The method also includes translating the specified simulation model of the circuit to at least one desired circuit simulator.

A third aspect of the invention relates to computer program product. In an exemplary embodiment according to the invention, a computer program product includes a computer application that may be processed by a computer. The computer program product causes the computer to provide an object-oriented application program interface (API) to specify a simulation model of a circuit. The computer program product further causes the computer to translate the specified simulation model of the circuit to at least one desired circuit simulator.

### DESCRIPTION OF THE DRAWINGS

The appended drawings illustrate only exemplary embodiments of the invention and therefore should not be considered as limiting its scope. The disclosed inventive concepts lend themselves to other equally effective embodiments. In the drawings, the same numeral designators used in more than one drawing denote the same, similar, or equivalent functionality, components, or blocks.

FIG. 1 shows a block diagram of a simulation compiler according to an exemplary embodiment of the invention.

FIG. 2 illustrates a block diagram of a system for processing information according to the invention.

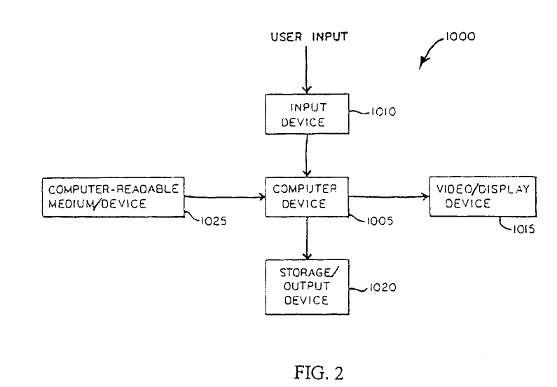

### DETAILED DESCRIPTION

This invention contemplates simulation compiler methods and apparatus for circuit characterization. As noted above, when characterizing circuits, making the desired measurements of the circuit characteristics in a simulator-independent fashion is a desirable property. Simulation compilers according to the invention solve this problem by providing an object-oriented application program interface (API) to specify simulation(s) (simulation model(s)) of the electronic circuit), and translating the specified simulation(s) to one or more desired circuit simulators or circuit simulator types.

More specifically, simulation compilers according to the invention solve the following problems:

efficient simulation specification for multiple simulator targets

sweeping of non-electrical parameters

collation of results from multiple simulator runs

optimization of various non-time related parameter types, which can be based on generic optimization failure formulas

automated calculations based on measurement results

direct, high-level support for multi-pvt and equation based characterization.

Other characterization solutions may use scripting languages (PERL mainly) to implement measurements in spice decks. Further, some may even generate decks for different simulators.

The Simulation Compiler has several distinct advantages over these techniques:

object oriented API specification—other solutions do not offer an object oriented API for specification of simulations. They are structured solutions that dive strait into writing the text in s spice deck from the top-level program. The object-oriented API provides an encapsulated repository for all simulation design elements, a boundary for testing the design transaction, and a layer that isolates simulation design from simulator specific implementation. Also, the API provides high level, characterization specific features such as specialized sweeps, sweep decomposition, transparent collation of results from multiple simulator runs, time-dependent parameters defined in terms of stimulus, and a calculation layer for compound measurements, as described in detail below.

specialized sweeps—characterization is based on taking the same measurement under varied conditions. The specific conditions that are varied are referred to as sweeps. Most simulators provide constructs for varying times and device parameters such as voltages, resistance, and capacitances. Simulation compiler provides constructs for varying many more types for elements which are essential to characterization. These include: process, temperature, supply voltages, options sets, CUT netlist, even the target simulator.

sweep decomposition specific to target simulator—in addition to supporting specialized sweep constructs, Simulation Compiler decomposes sweeps based on the most efficient use of the specific target simulator capabilities. For example, if one simulator supports multiple temperature declarations, then Simulation Compiler will implement a temperature sweep using this construct. If another target simulator does not, then Simulation Compiler will write multiple decks.

transparent collation of results from multiple simulator runs—many times, Simulation Compiler writes several decks in order to implement the sweeps for a simulation specification. This requires multiple runs of the simulator. Using multiple runs requires the collation of the results from multiple listings back into the original sweep ordering from the specification. This process is handled as needed by the simulation compiler, transparently to the user of the object-oriented API.

time-dependent parameter definition in terms of stimulus—many time dependent elements of a typical characterization simulation are inextricably linked to the stimulus of the circuit under test. The Simulation Compiler API allows for stimulus determination by a specialized module. Subsequently, other modules specialized in the art of measurement design can add measurements to the API and use stimulus constructs to define time-dependent parameters. This makes measurements, transient analysis time, and optimizations all easier to specify. It also reduces error from redundant routines that calculate the same time parameters.

measurement definitions that are independent from implementation—using Simulation Compiler a complex measurement which has varying support across simulators can be defined and parameterized at the Simulation Compiler level; subsequently, the measurement might be implemented differently in different target simulators based on their support for the concepts underlying it; for example an energy measurement might use an integral of current on one simulator and an average current on another.

calculation layer for exporting compound measurements—many times, measurements needed for cell characterization are composed of several spice-level acquisitions( e.g. delay, voltage, total charge, etc.). Simulation compiler allows the user to specify well-known higher level measurements and to compose his own on the fly by using the results of standard measurements in a calculation layer. This layering allows for convenient compound measurement specification and consistent measurement technique across users.

generic optimization engine—many measurements needed for characterization are actually parameter values that are attained using a search algorithm. Setup, hold and other constraints are just a few examples. Some simulators natively support optimization of certain types of parameters such as time. Others have not support at all. Simulation Compiler offers internal support for optimizing or searching for all types of parameters. In addition, the Simulation Compiler optimization engine takes a generic formula that indicates an optimization failure which is simulator and parameter type independent.

support for multi-pvt and equation based characterization—specialized sweeping, generic optimizations, and collation of results are essential for these advanced characterization techniques.

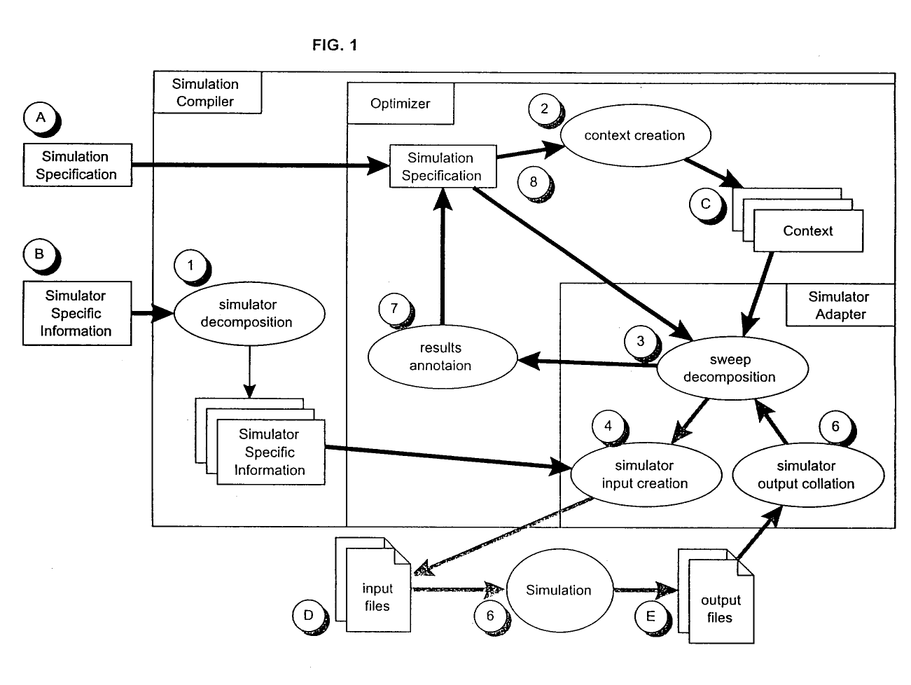

The following elements refer to labeled boxes in FIG. 1, labeled “Simulation Compiler Block Diagramg”. The oval blocks indicate processes and the rectangular blocks indicate artifacts or modules. The black arrows indicate the process flow. The red arrows indicate the optimization loop potion of the process flow. The green arrows indicate the simulation loop portion of the process flow. The blue arrows indicate that the artifact is required by the module or process at which the arrow points.

At a high level, the Simulation Compiler works by taking a specification for a simulation(A) and specific information about the target simulators(s)(B) and producing all the required inputs(5,E) for the target simulator, running the simulator(5), collating the simulator specific outputs(6,G) and annotating the Simulation Specification(A) with the final results(7).

At a slightly lower level, there are a few details and detours. If the user has specified multiple target simulators, the Simulation Compiler decomposes this request(1) before the Optimizer does context creation(2). If the Simulation Specification(A) calls for an optimization or a parameter value search, the optimization loop is traversed as many times as possible. If sweeps from the Simulation Specification(A) entail more that one simulator run, the Simulation Adapter performs sweep decomposition(4) and the Simulation Loop is traversed more that once.

| Process | Name | Description |
|---|---|---|
| 1 | simulator | if the Simulation Specification(A) contains a |
| | decomposition | sweep specifications for multiple target |
| | | simulators, the sweep requests will be |
| | | grouped by their target simulator and each |
| | | of the divided sweep sets will be run |
| | | through the Optimizer individually |
| 2 | context creation | the simulation specification(A) might |
| | | contain parameter references; the context |
| | | creation step creates a table of the values for |
| | | all parameters; if the Simulation |
| | | Specification(A) calls for an optimization or |
| | | a parameter value search, the context that is |
| | | generated contains a guess for this |
| | | parameter value; upon completion of |
| | | step(7), the Optimizer calculates another |
| | | guess(8) for this parameter and the red |
| | | Optimization loop is executed until no more |
| | | guesses are required |
| 3 | sweep | the sweep requests will be divided up |
| | decomposition | among the support structures of the target |
| | | simulator; some sweeps can be handled in |
| | | one spice deck, some are accomplished |
| | | through multiple decks; if multiple runs are |
| | | required, the green Simulation loop is |
| | | traversed more than once |
| 4 | simulator input | once the sweeps have been decomposed, the |
| | creation | Simulator Adapter creates the actual inputs |
| | | for all the required simulator runs; these |
| | | include spice decks, configuration files, |
| | | control files, etc. |
| 5 | simulation | this step represents running the simulator; |
| | | simulator runs generate outputs including |
| | | listing files, plots, result files, etc. |
| 6 | simulator output | the Simulator Adapter understands the |
| | collation | formatting of the simulator output and reads |
| | | in all the numerical results for the various |
| | | measurements and sweeps; it keeps track of |
| | | what results belong to what sweep and |
| | | measurement |
| 7 | results annotation | when the results are read in from the |
| | | outputs, they are annotated back to the |
| | | original Simulation Specification(A); the |
| | | original sweep ordering and measurement |
| | | specifications are retained |
| 8 | optimization loop | if the Simulation Specification(A) calls for |
| | | an optimization or a parameter value search, |
| | | this branch represents the creation of |
| | | additional guess; see also context |
| | | creation(2) |

Modules and Artifacts

| Module | Name | Description |
|---|---|---|
| A | Simulation | this is the heart of the object oriented API for |
| | Specification | simulation specification; it encompasses the simulator |
| | | independent design of the simulation; this include |
| | | things like the circuit-under-test(CUT), stimulus, |
| | | network harnesses, measurements to be taken and |
| | | calculations to make based on the measurement results, |
| | | parameter values, sweep specifications, optimizations |
| | | and the process, temperature, and options settings; |
| B | Simulator Specific | some information is simulator specific; this includes |
| | Information | options settings, netlists, process settings, network |
| | | implementations, etc.; these pieces of information are |
| | | classified and tagged in this artifact; the simulation |
| | | specification(A) references these tags in order to keep it |
| | | simulator independent; if multiple simulators are used, |
| | | then the tags are represented for every simulator |
| | | required |
| C | Context | a Simulation Specification(A) probably has parameter |
| | | references; sweeps and optimizations require parameter |
| | | references; the context is the table of parameter values |
| | | to be implemented in a simulator run; if the Simulation |
| | | Specification(A) calls for an optimization or a |
| | | parameter value search, the table contains guesses for |
| | | the optimized parameters and the guesses are refined |
| | | using the Optimization Loop |
| D | input files | simulator specific input files; these include spice decks, |
| | | configuration files, control files, etc. |
| E | output files | simulator specific output files; these include listing |
| | | files, plots, OP dumps, measurement results, etc. |

As persons of ordinary skill in the art with the benefit of the description of the invention understand, one may modify various aspects of the inventive concepts in a wide variety of ways. For example, one may use the following alternatives or variations:

any API package designed to specify simulations which solves the problems mentioned above

any API package that contains simulator independent definitions of networks, sweeps, measurements and results and drives multiple target simulators

any API package not directly associated with a target simulator which directly support multi-pvt or equation based characterization

To characterize a given circuit design using the inventive concepts, one typically uses a computer system that processes information relating to that circuit. FIG. 20 shows a block diagram of a system 1000 for processing information according to the invention. The system 1000 includes a computer device 1005, an input device 1010, a video/display device 1015, and a storage/output device 1020, although one may include more than one of each of those devices, as desired. The computer device 1005 couples to the input device 1010, the video/display device 1015, and the storage/output device 1020. The system 1000 may include more that one computer device 1005, for example, a set of associated computer devices or systems, as desired.

The system 1000 operates in association with input from a user. The user input typically causes the system 1000 to perform specific desired information-processing tasks, including circuit characterization and/or circuit simulation. The system 1000 in part uses the computer device 1005 to perform those tasks. The computer device 1005 includes an information-processing circuitry, such as a central-processing unit (CPU), although one may use more than one CPU or information-processing circuitry, as persons skilled in the art would understand.

The input device 1010 receives input from the user and makes that input available to the computer device 1005 for processing. The user input may include data, instructions, or both, as desired. The input device 1010 may constitute an alphanumeric input device (e.g., a keyboard), a pointing device (e.g., a mouse, roller-ball, light pen, touch-sensitive apparatus, for example, a touch-sensitive display, or tablet), or both. The user operates the alphanumeric keyboard to provide text, such as ASCII characters, to the computer device 1005. Similarly, the user operates the pointing device to provide cursor position or control information to the computer device 1005.

The video/display device 1015 displays visual images to the user. The visual images may include information about the operation of the computer device 1005, such as graphs, pictures, images, and text. The video/display device may constitute a computer monitor or display, a projection device, and the like, as persons of ordinary skill in the art would understand. If a system uses a touch-sensitive display, the display may also operate to provide user input to the computer device 1005.

The storage/output device 1020 allows the computer device 1005 to store information for additional processing or later retrieval (e.g., softcopy), to present information in various forms (e.g., hardcopy), or both. As an example, the storage/output device 1020 may constitute a magnetic, optical, or magneto-optical drive capable of storing information on a desired medium and in a desired format. As another example, the storage/output device 1020 may constitute a printer, plotter, or other output device to generate printed or plotted expressions of the information from the computer device 1005.

The computer-readable medium 1025 interrelates structurally and functionally to the computer device 1005. The computer-readable medium 1025 stores, encodes, records, and/or embodies functional descriptive material. By way of illustration, the functional descriptive material may include computer programs, computer code, computer applications, and/or information structures (e.g., data structures or file systems). When stored, encoded, recorded, and/or embodied by the computer-readable medium 1025, the functional descriptive material imparts functionality. The functional descriptive material interrelates to the computer-readable medium 1025.

Information structures within the functional descriptive material define structural and functional interrelations between the information structures and the computer-readable medium 1025 and/or other aspects of the system 1000. These interrelations permit the realization of the information structures' functionality. Moreover, within such functional descriptive material, computer programs define structural and functional interrelations between the computer programs and the computer-readable medium 1025 and other aspects of the system 1000. These interrelations permit the realization of the computer programs' functionality.

By way of illustration, the computer device 1005 reads, accesses, or copies functional descriptive material into a computer memory (not shown explicitly in the figure) of the computer device 1005. The computer device 1005 performs operations in response to the material present in the computer memory. The computer device 1005 may perform the operations of processing a computer application that causes the computer device 1005 to perform additional operations. Accordingly, the functional descriptive material exhibits a functional interrelation with the way the computer device 1005 executes processes and performs operations.

Furthermore, the computer-readable medium 1025 constitutes an apparatus from which the computer device 1005 may access computer information, programs, code, and/or applications. The computer device 1005 may process the information, programs, code, and/or applications that cause the computer device 1005 to perform additional operations.

Note that one may implement the computer-readable medium 1025 in a variety of ways, as persons of ordinary skill in the art would understand. For example, memory within the computer device 1005 may constitute a computer-readable medium 1025, as desired. Alternatively, the computer-readable medium 1025 may include a set of associated, interrelated, or networked computer-readable media, for example, when the computer device 1005 receives the functional descriptive material from a network of computer devices or information-processing systems. Note that the computer device 1005 may receive the functional descriptive material from the computer-readable medium 1025, the network, or both, as desired.

One may implement or use the inventive concepts in a variety of embodiments, as persons of ordinary skill in the art who have the benefit of the description of the invention understand. Referring to the figures, the various blocks shown depict mainly the conceptual functions and signal flow. The actual circuit implementation may or may not contain separately identifiable hardware, software, routines, algorithms, or the like, for the various functional blocks. For example, one may combine the functionality of various blocks into one block, as desired. Furthermore, one may realize the functionality of a single block in several blocks, as desired. The choice of implementation depends on various factors, such as particular design and performance specifications for a given implementation, as persons of ordinary skill in the art who have the benefit of the description of the invention understand.

Other modifications and alternative embodiments of the invention in addition to those described here will be apparent to persons of ordinary skill in the art who have the benefit of the description of the invention. Accordingly, this description teaches those skilled in the art the manner of carrying out the invention and are to be construed as illustrative only. As persons of ordinary skill in the art with the benefit of the description of the invention understand, one may make many modifications to the circuit arrangements described here and shown in the accompanying figures, as desired, without departing from the inventive concepts.

Furthermore, persons skilled in the art may make various changes in the shape, size and arrangement of parts without departing from the scope of the invention described in this document. For example, persons skilled in the art may substitute equivalent elements for the elements illustrated and described here. Moreover, persons skilled in the art who have the benefit of this description of the invention may use certain features of the invention independently of the use of other features, without departing from the scope of the invention.

I claim:

1. A system for characterizing a circuit, comprising:
a computer adapted to:
provide an object-oriented application program interface (API) to specify a simulation model of the circuit; and
translate the specified simulation model of the circuit to at least one desired circuit simulator.

2. A method for characterization of a circuit, the method comprising:
providing an object-oriented application program interface (API) to specify a simulation model of the circuit; and
translating the specified simulation model of the circuit to at least one desired circuit simulator.

3. A computer program product, comprising:
a computer application processable by a computer for causing the computer to:
provide an object-oriented application program interface (API) to specify a simulation model of a circuit; and
translate the specified simulation model of the circuit to at least one desired circuit simulator.
